(19) United States
(12) Patent Application Publication
(10) Pub. No.: US 2007/0229282 A1
(43) Pub. Date: Oct. 4, 2007

(54) Identification and tracking tag

(76) Inventor: Cynthia A. Lowes, Wildwood, MO (US)

Correspondence Address: Galasso & Associates, LP, P. O. Box 26503, Austin, TX, 78755-0503, US

(21) Appl. No.: 11/395,651

(22) Filed: Mar. 31, 2006

(51) Int. Cl. G08B 13/14; G06K 19/00

(52) U.S. Cl. 340/572.8; 235/487

(57) ABSTRACT

A fire retardant tag which includes personal information about the owner including medical alerts, emergency contact information, blood type and insurance carrier. The tag also provides an identification marking which is indicative of a company where more information can be obtained about the owner. Additionally, the tag is equipped with a tracking device similar to a GPS chip which can be accessed from an individual computer. A decorative cover is also provided which fits over the fire retardant tag to prevent the information from being exposed to strangers and making the tag more attractive for wearing. It is capable of being worn as a necklace, bracelet, inserted into clothing or a wallet.

### FIELD OF THE DISCLOSURE

An identification tag having personal identification information and which is trackable based on a tracking device embedded within the device.

### BACKGROUND

In today's society more and more children are disappearing. They can be playing in their front yard, simply get out of their parent's site at a mall or grocery store and never be seen again. This is a very frightening thought and for any parent who has been through it a living nightmare. Unfortunately, most of the children who are abducted are later found dead or even worse never found.

Teenagers are another story in that they often go out for an evening with friends or on a date and forget to come home or even worse they end up in an accident of some kind. There is a growing number of teenagers who are involved in automobile accidents every day. The first thing that goes through the mind of any parent when their teenager does not come home is whether they have been involved in accident.

If your child is involved in serious accident, medical information regarding your child is not always readily accessible. For example, if your child is allergic to a particular drug or has a condition such as asthma that might affect the immediate treatment they would receive, would you want the medical personnel to have this information as quickly as possible. In a serious accident, a child could be given medication that could potential become life threatening while attempts are being made to contact the parent or guardian. If the information was readily accessible with the child, it could potentially be life saving.

While parents want to know where their children are at all times, it is just not possible. Furthermore, every parent wants to believe that their child is always safe and this is not always the case. Unfortunately, bad things happen to children every day. Not only are they kidnapped, sometimes by people they know, but accidents happen on a daily basis.

Children are not the only ones that are kidnapped or involved accidents though. Adults disappear on a regular basis as well. Furthermore, adults are involved in accidents on a daily basis too. For the loved ones of those involved in disappearances and accidents, the waiting for information is undescribable.

There has been a lot of emphasis placed on tracking of various things, including automobiles and pets. Some companies have even created devices capable of tracking packages, luggage and crates. More recently, implantable devices have been designed for tracking human beings. These devices are similar to those that are currently implanted into pets. They require that the device be inserted into one's body. Because it is a foreign object being inserted into one's body, it is not always a desirable choice. Most adults don't want to be able to be monitored this closely and most parent's would not want to put their child through this type of procedure and would not want someone else to be able to monitor their child's constant whereabouts. While all parents are aware that children disappear on a daily basis, most parents don't believe that it will ever happen to them and their child.

However, if a device was available that provided a certain degree of protection and trackability which could be monitored the parent, it would provide parents a certain amount of security when their child left the safety of their homes.

### SUMMARY OF THE DISCLOSURE

In one embodiment the identification device comprises a fire retardant tag.

In another embodiment the identification tag comprises a tracking device.

In still another embodiment the identification tag includes a list information.

In yet another embodiment the list of information is imprinted onto the fire retardant tag.

In another embodiment the identification device comprises a decorative case.

In still another embodiment the fire retardant tag is inserted into the decorative case.

In yet another embodiment the identification device comprises an identification symbol.

In another embodiment the list of information includes an individual's name.

In still another embodiment the list of information includes an individual's blood type.

In yet another embodiment the list of information includes emergency contact information.

In another embodiment the list of information includes medical alerts.

In still another embodiment the list of information includes the insurance provider.

In yet another embodiment the tracking device is capable of being tracked from an individual's computer.

In another embodiment the tracking device is a GPS chip.

In still another embodiment the identification symbol is indicative of a number to call for more information.

In yet another embodiment the fire retardant tag is capable of being worn as a necklace.

In another embodiment the fire retardant tag is capable of being worn as a bracelet.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 illustrates a information tag comprising personal information.

FIG. 2 illustrates the back of the information tag depicted in FIG. 1.

FIG. 3 illustrates a decorative case for inserting the information tag depicted in FIG. 1.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

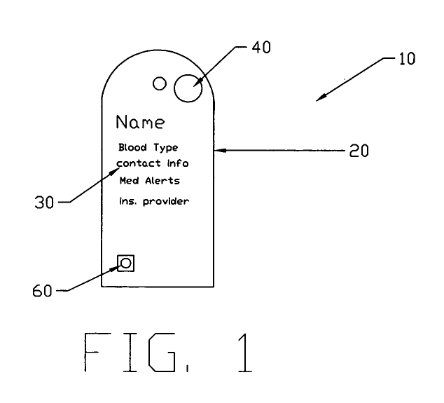

FIG. 1 illustrates an identification device 10 which is comprised of a fire retardant tag 20. The fire retardant tag 20 includes a list of information 30 which includes an individual's name, an individual's blood type, emergency contact information, medical alerts and insurance provider. Additional items can be included on the list of information 30 which may include date of birth, address and phone number. The information may be adhered to the fire retardant tag 20 or actually imprinted into the fire retardant tag 20 in a manner consistent with identification tags which are worn by soldiers. The fire retardant tag 20 is also equipped with a tracking device 40. The tracking device 40 is embedded in the fire retardant tag 20 and can be a GPS chip or any other type of tracking device 40 that can be accessed from an individual's home computer.

FIG. 1 also illustrates an identification symbol 60 which is indicative of a number to call for more information regarding the particular identification device 10. This way, in an emergency, emergency personnel can contact a specific number which would be able to provide more information quickly regarding the user. Additionally, by calling this number they could assist in locating the proper emergency contact.

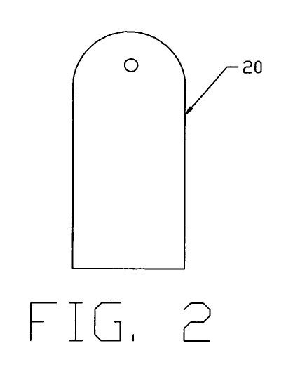

FIG. 2 is a back view of the fire retardant tag 20 and illustrates that the fire retardant tag 20 is equipped with a hole that allows a chain or other type of device to be inserted thereby allowing the user to wear the tag as a necklace, bracelet or other type of adornment.

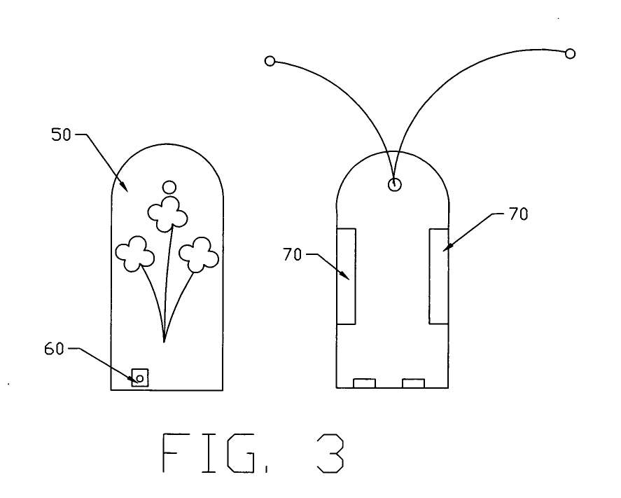

FIG. 3 illustrates a front and back view of the fire retardant tag 20 showing that the decorative case 50 which equipped with a hole located on one end that allows for an chain to be inserted allowing the user to wear the fire retardant tag 20 as a necklace or a bracelet or other type of adornment. The identification device 10 also includes a decorative case 50. The decorative case 50 can include various types of decorations. It could be adorned with an individual picture, pictures of stars or musicians, horoscope signs or various other decorative emblems.

The back of FIG. 3 illustrates the metal holding grooves 70 which holds the fire retardant tag 20 to the decorative case 20. The fire retardant tag 20 is slid into the metal holding grooves 70. The allows a user to change the decorative case 50 depending on their mood or attire. By allowing the user to change out the decorative case 50, it gives them the opportunity to incorporate the identification device 10 into their daily dress.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. An identification device comprising:
a fire retardant tag;
a tracking device;
a list of information wherein said information is imprinted on said fire retardant tag;
a decorative case wherein said fire retardant tag is inserted into said decorative case;
an identification symbol.

2. The identification device of claim 1 wherein said list of information includes an individuals name.

3. The identification device of claim 1 wherein said list of information includes an individuals blood type.

4. The identification device of claim 1 wherein said list of information includes emergency contact information.

5. The identification device of claim 1 wherein said list of information includes a list of medical alerts.

6. The identification device of claim 1 wherein said list of information includes the insurance provider.

7. The tracking device of claim 1 wherein said tracking device is capable of being tracked from an individual's computer.

8. The tracking device of claim 1 wherein said tracking device is a GPS chip.

9. The identification symbol of claim 1 wherein said identification symbol is indicative of a number to call for more information.

10. The fire retardant tag of claim 1 wherein said fire retardant tag is capable of being worn as a necklace.

11. The fire retardant tag of claim 1 wherein said fire retardant tag is capable of being worn as a bracelet.

12. An identification system comprising:
a fire retardant tag;
a tracking device wherein said tracking device is capable of being tracked from an individual computer;
a list of information wherein said information is imprinted on said fire retardant tag; and wherein said list of information includes an individuals name, blood type, emergency contact information, medical alerts and insurance providers;
a decorative case wherein said fire retardant tag is inserted into said decorative case;
an identification symbol wherein said identification symbol is indicative of a number to call for additional information.

13. The tracking device of claim 12 wherein said tracking device is comprised of a GPS chip.

14. The fire retardant tag of claim 12 wherein said fire retardant tag is capable of being worn as a necklace.

15. The fire retardant tag of claim 12 wherein said fire retardant tag is capable of being worn as a bracelet.
